(19) United States
(12) Patent Application Publication
(10) Pub. No.: US 2004/0052320 A1
(43) Pub. Date: Mar. 18, 2004

(54) Point-to-multipoint burst modem automatic gain control

(76) Inventor: Gary R. Lennen, Cupertino, CA (US)

Correspondence Address: ROBERT E. KREBS, THELEN REID & PRIEST LLP, P.O. BOX 640640, SAN JOSE, CA, 95164-0640, US

(21) Appl. No.: 10/081,447

(22) Filed: Feb. 20, 2002

(51) Int. Cl. H04L 27/08

(52) U.S. Cl. 375/345

(57) ABSTRACT

The methods and apparatuses described herein allow very rapid AGC lock onto a burst radio frequency transmission. The advantage of these methods and apparatuses is that they allow rapid acquisition of packets, i.e. there is no multi-packet AGC training time before the packet data can be demodulated. The methods and apparatuses also allow the portion of the packet allocated to AGC acquisition time to be shortened, increasing system efficiency as a higher percentage of time is available for user data. The AGC techniques described herein use a novel method to acquire lock rapidly. If the signal is observed to be hardlimiting the A/D output the gain is reduced substantially. If the signal is observed to be in the linear operating portion of the A/D outputs operating range a single measurement is made to pull the AGC loop into its desired operating point.

### FIELD

The invention relates to modem communications. More specifically, the invention relates to automatic gain control processing in a modem receiving a burst communication signals.

### BACKGROUND

Wireless modems are devices that transmit and receive radio waves for the purpose of communicating information. Wireless modems can be classified as continuous or burst devices. In a continuous modem system the radio waves are received or transmitted constantly. This requires the transmit and receive carrier waves to be significantly different frequencies in order to prevent the continuous transmit operation from interfering with the continuous receive operation.

In burst modems the transmit and receive frequencies can be the same frequency with interference being prevented by timing the transmission and reception of signals such that the transmission and reception do not occur at the same time. This is known as time division duplexing or TDD. By transmitting and receiving on the same frequency the communications equipment does not require an expensive Diplexer component (a device used to help reduce interference between transmit/receive frequencies) that are used in continuous modems.

Burst modem operation is typically used in point to multi-point (PMP) radio systems. PMP systems transmit information from a single location, also known as a Hub, to many destination devices. The destination devices in turn transmit information back to the Hub. The Hub is typically further connected to the Internet, a telephone system, or another other network. Burst modem operation is used in PMP systems to make user equipment less expensive and to allow data usage flexibility. The length of the bursts may be adjusted to match the coordination and data requirements of a particular user, with shorter data packets being sent for users requiring little data bandwidth and longer packets for higher data bandwidth requirements.

Reception of data requires coordination between the transmitting device and the receiving device(s). One of the requirements of the coordination process is automatic gain control (AGC), which refers to an adaptive system that operates over a wide dynamic range while maintaining an output signal at a constant level. AGC is used in modems because several modules within modems use amplitude thresholds for making operational decisions. These thresholds should remain generally constant over the entire dynamic range of input signals. The general concept of AGC is known in the art and has been used with many modems.

The distance between Hub and users can vary significantly. This leads to large variations in received power levels, typically varying by 60 dB or more. For example, one user may be 100 meters from the Hub location and another 10 km. This difference in distance alone causes the more distant user to observe 40 dB less power than the nearby user. Multi-path fading, transmit power variation and other effects can add to this power receive variation.

The operating range of the receiver analog-to-digital converters is deliberately limited to reduce the cost and power consumption of the analog-to-digital converters. Analog-to-digital converters with more bits could be used but these are more expensive, consumes more power and are often difficult to obtain for higher frequency operation (i.e. higher data rates).

Current AGC techniques are typically designed to operate with constant modems. For example, in normal home use, a modem is connected to a telephone line and the modem has exclusive use of the telephone line during communications using the modem. Thus, a data stream is constantly flowing in and/or out of the modem via the telephone line. These AGC techniques are inefficient when used in burst communications environments.

### SUMMARY OF THE INVENTION

A burst transmission signal having a first (I) component and a second (Q) component is received. The signal is amplified with a variable gain amplifier. The magnitude of the amplified signal is sampled. The amplification provided by the variable gain amplifier is reduced by an amount greater than a predetermined headroom magnitude between a maximum signal level and a desired signal level if the magnitude of the amplified signal exceeds the maximum signal level. The magnitude of the signal amplified with the reduced amplification is sampled to determine whether the reduced amplification causes the signal to be within a predetermined range.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of a modem.

FIG. 2 is a block diagram of the receive baseband section and RX processor of FIG. 1.

FIG. 3 illustrates one embodiment of desired IQ constellation points with respect to the range of values available from the A/D converter outputs.

FIG. 4 is a block diagram of one embodiment of a RX processor.

FIG. 5 illustrates a typical burst modem transmission packet format.

FIG. 6 is a flow diagram of one embodiment of an AGC lock technique.

FIG. 7 is a flow diagram of one embodiment of a technique for removing the gain difference between I and Q channels.

FIG. 8 linear to log scale translation function graphic.

### DETAILED DESCRIPTION

Techniques for Automatic Gain Control (AGC) in burst modems are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The methods and apparatuses described herein allow for a more rapid AGC lock onto a burst radio frequency transmission than use of traditional continuous modem AGC lock techniques. This allows rapid acquisition of packets, i.e. there is no multi-packet AGC training time before the packet data can be demodulated as required by traditional burst AGC techniques. Thus, AGC acquisition time can be shortened compared to traditional techniques, which increases system efficiency because a greater percentage of time is available for user data.

As an overview, the AGC techniques described herein acquire lock relatively rapidly. If the signal is observed to be hardlimited, the analog to digital converter output the gain is reduced substantially. If the signal is observed to be in the linear operating portion of the analog to digital converter, a single measurement is made to pull the AGC loop into its desired operating point.

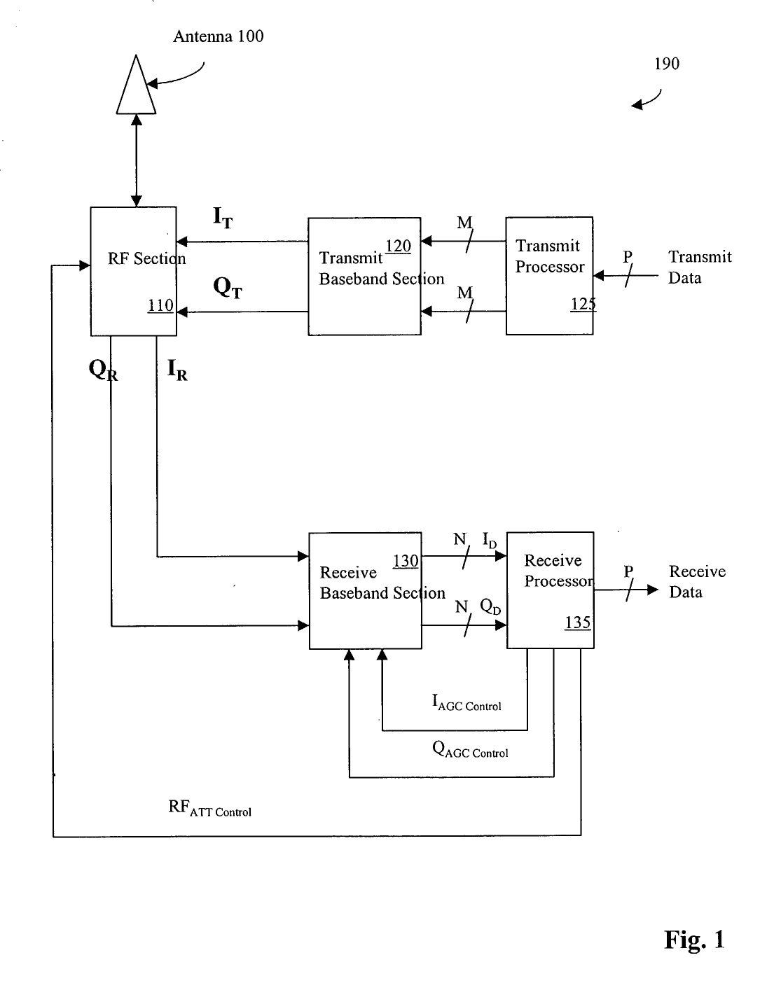

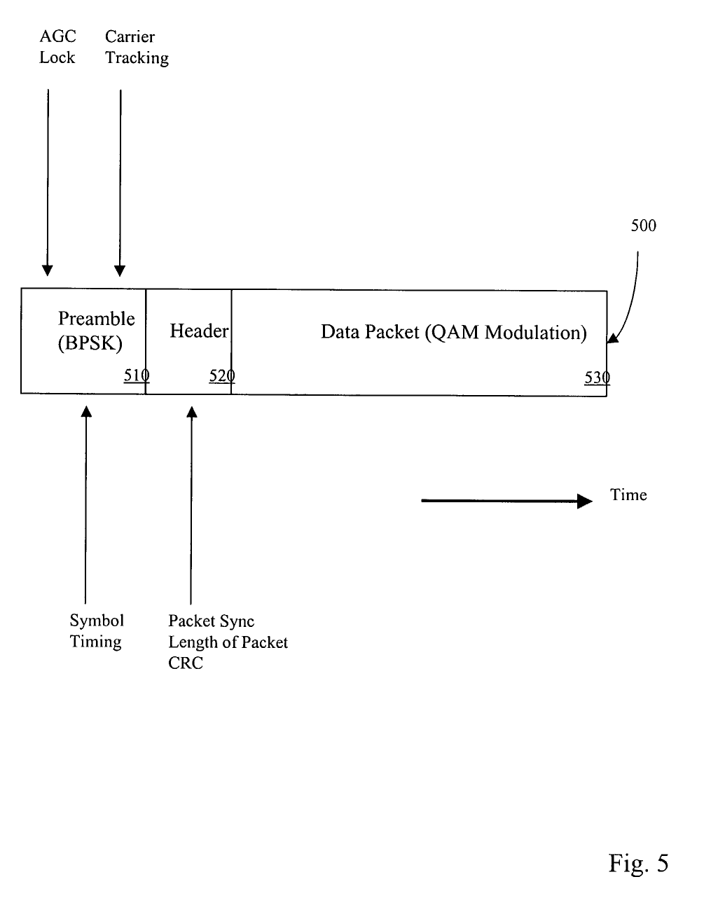

FIG. 1 is a block diagram of a modem. Modem 190 is intended to represent a broad category of modems that can include additional and/or different components as compared to the block diagram of FIG. 1. In one embodiment, modem 190 is a burst modem that transmits and receives data packets such as the data packet described below with respect to FIG. 5.

Antenna 100 typically points at the hub location (not shown in FIG. 1), for user equipment and defines a hub sector for the hub antenna. Microstrip patch antennas and parabolic antennas are two possible configurations; however, other types of antennae can be used. In one embodiment, antenna 100 is used for both transmit and receive operations. In alternate embodiments, multiple antennae can be used for transmitting and/or receiving data. Antenna 100 can be any type of antenna known in the art and can be configured in any manner known in the art.

Antenna 100 is coupled with radio frequency (RF) section 110. In one embodiment, antenna 100 is coupled with RF section 110 with an RF cable; however, other types of coupling media can be used. In general, RF section 10 performs frequency translation operations (e.g., up for transmit signal, down for receive signal), amplification and filtering functionality. RF section 100 can also switched between transmit and receive cycles to facilitate time division multiplexed (TDD) mode. RF section 100 can be implemented in any manner known in the art.

In one embodiment, RF section 110 contains a switched attenuator device that is controlled via signal RF_{ATT Control}. This signal is generated as part of the AGC technique to be described below. In general, a switched attenuator is a device that has two states, one of low attenuation and one of relatively high attenuation. For the purposes of describing the AGC technique these states are approximately 0 dB and K dB attenuation. The switched attenuator increases the dynamic range of received signal over which the modern can operate. The switched attenuator may be included at any downconversion frequency stage.

RF section 110 receives signals I_{T} and Q_{T} as inputs. These are signals generated by transmit baseband section 120, which in turn receives M-bit digital signals from transmit processor 125. Transmit processor 125 receives the data to transmit as its input signal. The functions of transmit baseband section 120 and transmit processor 125 are not described in further detail as they are known in the art and not required for AGC purposes.

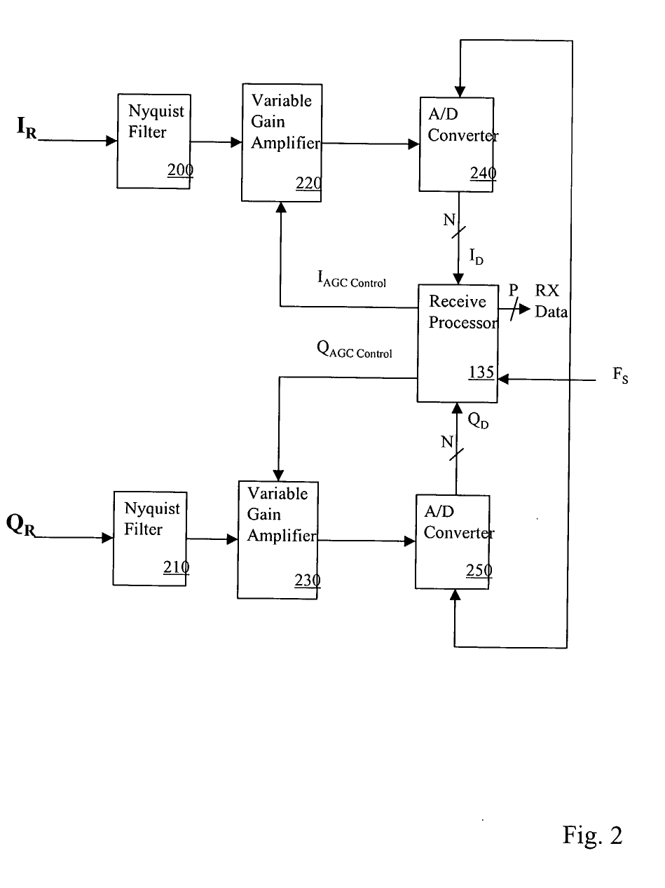

When in receive mode, RF section 110 sends signals I_{R} and Q_{R} to receive baseband section 130. The lit and Q_{R} signals represent the signals received by antenna 100. Receive baseband section 130 (described in more detail in FIG. 2) receives control signals I_{AGC Control} and Q_{AGC Control} that are generated by receive processor 135 for the purpose of adjusting the signal gain. Among other things, receive processor 135 operates on the digitized signals I_{D} and Q_{D} to compute an estimate of the gain control adjustment required to bring the values I_{D} and Q_{D} to the desired operating range. Receive processor 135 outputs the P-bit data stream “Receive Data” that represents the equivalent of the original data that was transmitted at the other end of the link.

Receive processor 135 also generates the RF_{ATTControl} signal that is used by RF section 110 to select between attenuation levels. The generation of the RF_{ATTControl} signal described in greater detail below.

FIG. 2 is a block diagram of the receive baseband section 130 and receive processor 135 of FIG. 1. The receive baseband section includes Nyquist filters 200 and 210, variable gain amplifiers 220 and 230, and analog to digital converters 240 and 250. Analog signals I_{R} and Q_{R} are pulse shaped in Nyquist filters 200 and 210, respectively. The purpose of Nyquist filters 200 and 210 is to complete the equalization of the channel (the channel is the signal transmission path including transmit/receive hardware and the wireless signal path). A correctly equalized channel provides an optimal sampling point for data extraction.

The I_{R} and Q_{R} signals are then passed through variable gain amplifiers (VGAs) 220 and 230, respectively. VGAs 220 and 230 adjust the gain of the incoming signals to be within a desired dynamic range. The gain provided by VGAs 220 and 230 is controlled by receive processor 135 by generating signals I_{AGCControl} and Q_{AGCControl}. The gain control signals are generated as described in greater detail below.

The basic use of a VGA within a modem can be described with two examples. In the first example, if the signal presented at the input to the analog-to-digital (A/D) converters is very large the output of the A/D converters will consist of only two values, which are the maximum and minimum values supported by the A/D converter. Assuming an 8-bit signed output, those two values will be −128 or +127. This limiting has an unacceptable effect on system performance. For quadrature phase shift keyed (QPSK) signals there is a signal to noise ratio penalty, for higher QAMs the information originally transmitted in the signal is lost and unrecoverable. Hence it is desirable to avoid this limiting condition.

For the second example, if the signal presented at the input to the A/D converters is very small the output of the A/D converters will be dominated by quantization noise created by the A/D converters themselves. Each bit in the A/D converter reduces quantization noise by 6 dB. A practical example is in the reception of QPSK signals. For uncoded QPSK a signal to noise ratio (SNR) of 13.5 dB is required for a bit error rate (BER) performance of 1 error in 10⁶ transmitted bits. A higher SNR is required for further improved BER performance. If the signal input to the A/D converters is small enough that it only toggles the least significant bit (LSB), this will provide a quantization generated SNR of only 6 dB (i.e. not high enough for acceptable BER performance for the application).

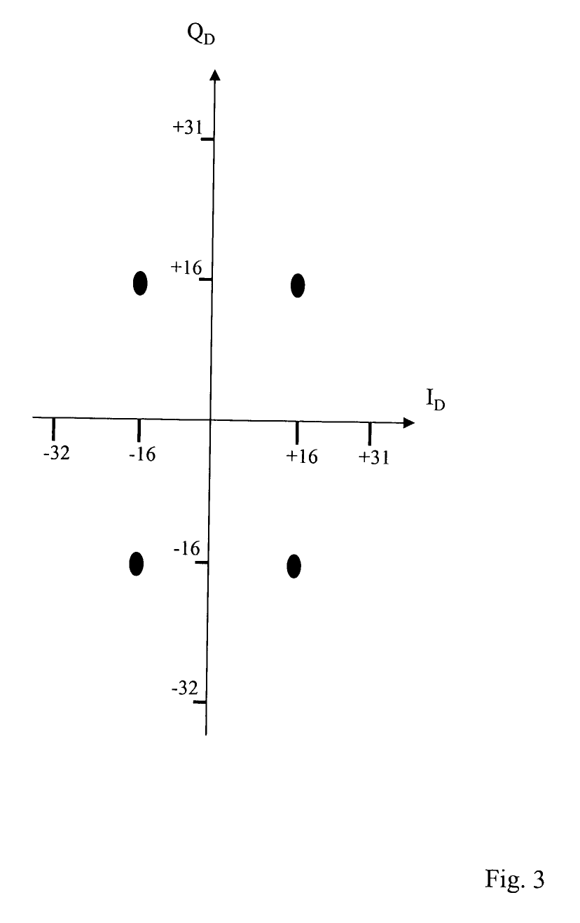

Continuing the examples given above, if a 6-bit (N=6 in FIG. 2) A/D converter is used, it is desirable to leave at least 6 dB (one quantization bit) headroom, such that the average signal nominally resides at half the maximum A/D converter range. FIG. 3 illustrates one embodiment of desired IQ constellation points with respect to the range of values available from the A/D converter outputs. One bit used for signal headroom leaves 5 bits for signal sign and magnitude representation, giving a quantization noise generated SNR of 5 times 6 dB=30 dB.

Returning to FIG. 2, F_{S} is the sampling rate signal which is typically 2× symbol rate. In one embodiment, F_{S} is a clock signal generated by a clock circuit (not shown in FIG. 2). In alternate embodiments, F_{S} is generated by a different circuit element. The A/D converters 240 and 250 and receive processor 135 are synchronously sampled at this rate.

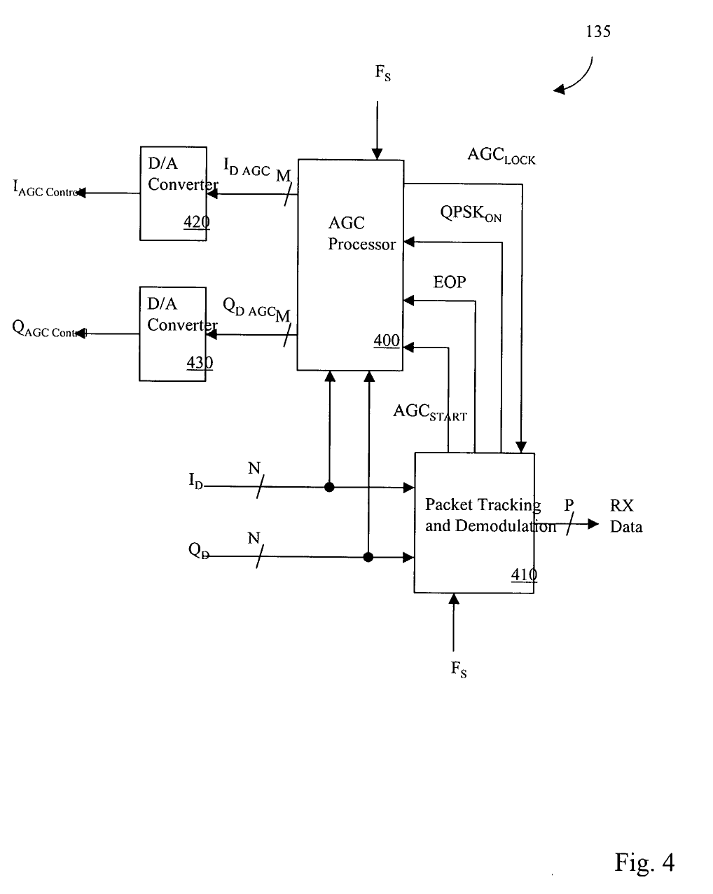

FIG. 4 is a block diagram of one embodiment of a receive processor, for example, receive processor 135 of FIG. 1. Automatic gain control (AGC) processor 400 provides output M-bit digital signals I_{D AGC} and Q_{D AGC} that are passed through D/A converters 420 and 430, respectively, to provide the VGA control signals I_{AGC Contol} and Q_{AGC Control}. The signals I_{D AGC} and Q_{D AGC} are generated by AGC processor 400 as described in greater detail below.

Independent I and Q control signals are provided because a gain offset could exist between I and Q analogue sections. Compensation for the offset is described below. In another embodiment where IF sampling is used a single control may suffice as I and Q signals are all digital and hence do not vary with component and temperature variation.

AGC Processor 400 uses the N-bit signals I_{D} and Q_{D} as inputs. These signals are also passed to packet tracking and demodulation circuit 410, which performs a number of functions including symbol timing, carrier tracking, error correction, etc. Packet tracking and demodulation circuits are known in the art and is therefore not described in detail. AGC processor 400 also provides a signal AGC_{LOCK} that indicates when the AGC is considered locked. This signal is used by packet tracking and demodulation circuit 410 to trigger symbol timing followed by other functions.

Packet tracking and demodulation circuit 410 provides a signal, AGC_{START}, that is used to initialize AGC processing by AGC processor 400. Generation of this signal may depend on a number of factors, including, for example, the expected time of arrival of the packet. It may be set considerably before the actual arrival of the packet in a system that does not have accurate knowledge of packet arrival time. In a system where time is known accurately the AGC_{START} signal could be synchronized with the arrival time of the packet. The important characteristic is that in order to minimize the length of preamble required to acquire AGC_{LOCK} the AGC algorithm should be initiated at or before the beginning of the packet's arrival.

Packet tracking and demodulation circuit 410 provides two other signals to AGC processor 400. The EOP (End of Packet) signal is set true when the packet has ended and false during the packet. The QPSK_{ON} signal indicates when the QPSK or higher order modulation signal is being received.

FIG. 5 illustrates a typical burst modem transmission packet format. Packet 500 consists of three main sections. The first section is preamble 510, which enables the functions of AGC lock, symbol timing and carrier tracking. The technique described herein operates primarily on this portion of the packet. The techniques described herein allow a reduction the length of preamble required to ensure successful AGC lock before other functions are performed. In one embodiment, the functions are performed sequentially, with AGC lock performed before other functions (symbol timing and carrier tracking).

In header section 520 of packet 500 a number of functions are performed that require tracking of the signal prior to data demodulation. Data section 530 contains the information carried by packet 500. In one embodiment, preamble 510 consists of a BPSK transmitted maximal length shift register (MLSR) sequence. BPSK is desirable as a preamble modulation format as it provides good performance for carrier tracking.

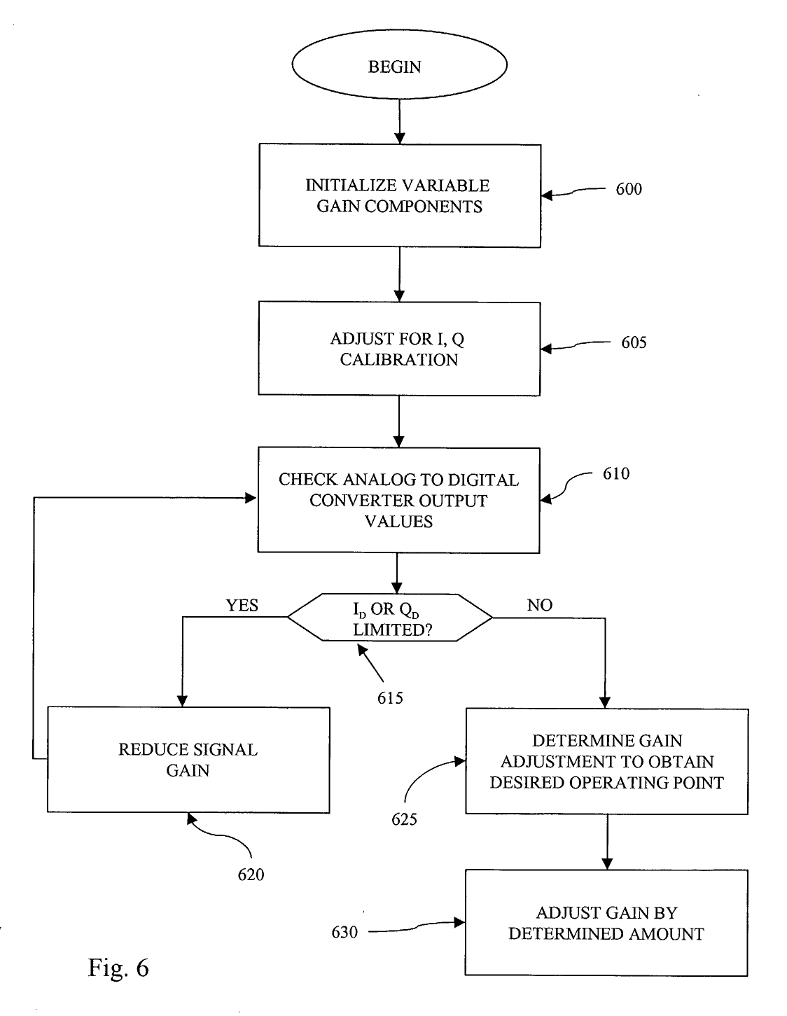

FIG. 6 is a flow diagram of one embodiment of an AGC lock technique. The AGC lock technique can be performed, for example, by a state machine that may be implemented on an FPGA (Field Programmable Gate Array), ASIC (Application Specific Integrated Circuit) or in software on a DSP (Digital Signal Processor). The AGC lock technique can also be performed by a processor executing instructions.

The adjustable gain blocks (e.g., the VGAs and the RF attenuator) are initialized, 600. In one embodiment, the value RF_{ATT} is set to 0 dB. This represents the setting of the RF attenuator, which has two settings (0 dB and K dB). The AGC_{LOCK} indicator is set to false to indicate the AGC is not locked to the incoming signal. A counter ‘m’ is initialized to zero. This counter is used when summing multiple gain readings (Y_{gain},) described later. In one embodiment, the summing initially occurs over an interval of N=16 samples. In one embodiment, after AGC_{LOCK} has been obtained the value of N is changed to 32 to provide more averaging after AGC_{LOCK} has been declared.

The current value to be written to the digital to analog converter (DAC) is Jₖ. The DAC is used to update the VGA gain. A typical DAC suitable for this application is the AD9709 manufactured by Analog Devices Inc. A typical A/D suitable for this application is the AD9288, also manufactured by Analog Devices Inc. A typical VGA is the AD604 from Analog Devices Inc. Jₖ₋₁ represents the value last written to the DACs. The value Jₖ is initialized to half its maximum range, the example here has a DAC input number range of 0 . . . 255 and Jₖ is initialized to 128.

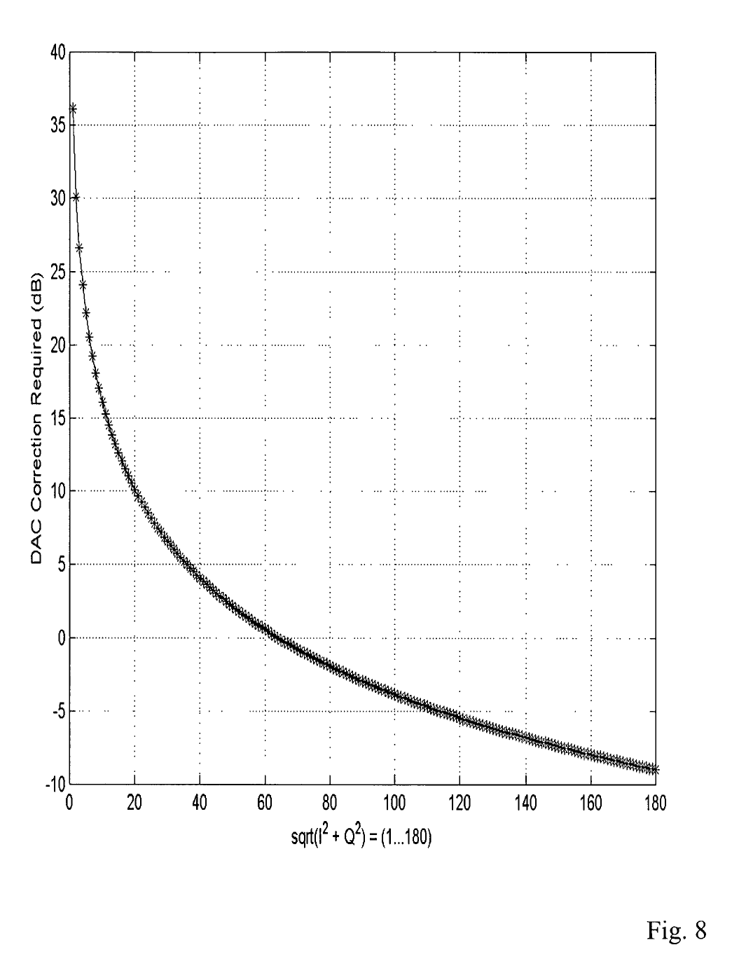

In one embodiment, the VGA takes a voltage control input range from 0V to 2V. This represents the DAC input number range 0 . . . 255 and the VGA ranging from minimum to maximum gain. The linear range 0V to 2V is translated by the VGA into a dB (or log) range, of, for example, 0 dB to 60 dB. This translation is illustrated by the curve shown in FIG. 8.

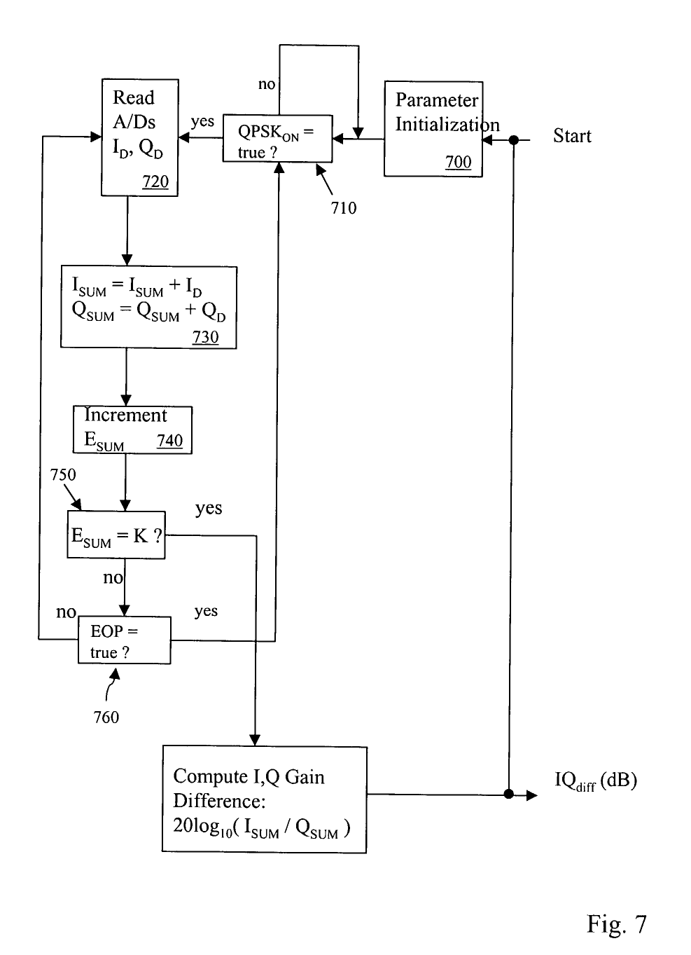

After parameter initialization, an optional adjust for I, Q calibration operation can be performed, 605. One embodiment of a technique for adjusting for 1, Q calibration is described in greater detail below with respect to FIG. 7. A value IQ_{diff} represents the gain difference between I and Q. If IF sampling is used this is not required as I and Q gains will already be balanced because the baseband portion of the signal path is all digital with well controlled gains. The IQ_{diff} value means that only one of the I or Q channels get adjusted with this value as it is relative to the other channel.

In one embodiment, a time delay inserted to compensate for the time it takes the values written to the DACs to have an effect on the output of the DACs. After the delay, the AJDs are read, providing values I_{D} and Q_{D}. The values output from the A/D converters (ID and QD) are then checked for limiting, 610. In one embodiment, the output of the A/D converters cannot go below zero or above 255 for an 8-bit unsigned number. A/D converters of other sizes can also be used.

If the AGC_{LOCK} flag has previously been set true limiting is not checked and the Y_{gain} (vector length) is computed. If I_{D} or Q_{D} is limited the last value of Jₖ written to the DACs is checked. If Jₖ₋₁ is less than P dB the gain of the VGAs cannot be lowered enough and the RF attenuation is increased to K dB, this should bring the signal level back into the range of the VGAs. Jₖ is also set back to its mid-range value. If the Jₖ is greater than or equal to P dB the VGA gain can be adjusted to bring the signal gain to the desired operating point. A new Jₖ=Jₖ₋₁−P dB value is created and passes through the states required to write this value to the DACs.

If either of I_{D} and Q_{D} are limited, 615, the corresponding signal gain is reduced 620. If “I_{D} or Q_{D} Limited?” results in a “no” the vector Y_{gain} is computed. This value is accumulated into the value Y_{SUM}. The accumulation period m is incremented in the next state and then checked against the accumulation period N. If the accumulation period has not ended the state machine returns to read the A/D values again. If the accumulation period has been reached the counter m is set to zero to prepare for the next accumulation period. The next state computes whether the accumulated vector Y_{SUM} is less than 1 dB away from the desired operating gain point. If the vector is within 1 dB the AGC is considered locked and the value AGC_{LOCK} is set true. If the vector is not within 1 dB the vector is checked to determine if it is greater than 3 dB from the desired operating point.

If greater than 3 dB from the operating point, the AGC loop is considered not locked and the value AGC_{LOCK} is set to false. The values 1 dB and 3 dB correspond to one embodiment. They may be altered along with the integration period N to provide a more or less accurate AGC lock point. This is a trade off between time for the AGC loop to lock and the accuracy guaranteed when declaring lock. Higher order Data Packet modulations require more accurate AGC and hence require longer integration times (higher N) and more accurate lock declaration e.g. 1 dB replaced by 0.5 dB, and 3 dB replaced by 1 dB.

Remembering that, in one embodiment, the typical desired amplitude is half the maximum range of the A/D converters, this translates into a difference between the desired point and limiting of 3 dB in voltage amplitude (or 6 dB in power amplitude). Hence, if it were assumed that the signal was exactly at the limiting position, the signal would have to be backed off by 6 db in power to obtain the desired operating point. In one embodiment, the signal gain is reduced by more than the 6 dB as there is a probability that the incoming signal is larger than exactly limiting.

If the signal is not limited a measurement is made of how much gain adjustment is required to obtain the desired operating point, 625. In one embodiment, this measurement involves averaging the signal vector Y_{gain} across N samples, and using this value to obtain the gain correction required via a lookup table. The gain of the signal is adjusted by the determined amount, 630.

After AGC_{LOCK} is set false, the integration period N is set to the lesser period (N=16). Loss of lock does not eliminate the possibility that the gain can be adjusted on the next cycle to the correct desired operating point. So the states continue to correct the gain via the normal process, described below.

FIG. 7 is a flow diagram of one embodiment of a technique for removing the gain difference between I and Q channels. In the description that follows, the technique of FIG. 7 is described in terms of a state machine and corresponding states. However, in alternative embodiments, other implementations can also be used to accomplish the technique described.

Non-digital implementations of Nyquist Filters, Variable Gain Amplifiers, A/Ds and other analog circuits that are repeated for I and Q channels are very difficult to make exactly balanced. As a result, in practice, there is typically several decibels of amplitude difference in the I and Q signals at the outputs of the A/Ds.

A portion of the packet that includes QPSK or higher order modulation that is guaranteed on average to transmit equal power in I and Q vectors is used to remove gain difference between the I and Q channels. The reason for this equal power in I and Q requirement is that with an unbalanced power modulation (e.g. BPSK) there is a high probability that the receive power in I and Q will not be equal (even without any gain imbalance caused by receive circuits). This disallows meaningful comparison between measurement of signal in I and Q channels. The QPSK or higher modulation portion of the packet typically occurs after AGC lock, symbol lock and carrier lock have been achieved i.e. during the Header or Data Packet portions shown in FIG. 5.

Typically, the gain offset between I and Q is relatively small (e.g., in the range of 2 dB), this means that this offset can be adjusted relatively slowly (i.e. over multiple packets). Although if high order modulation is used in the Data Packet portion (e.g. 64-QAM) the IQ gain offset should be corrected for before the AGC is accurate enough for reliable reception. Also note that modeni point to multi-point systems tend to use lower order modulation schemes because of their resistance to interference (including self interference between sectors).

The IQ Gain Offset Removal begins with parameter initialization, 700. In one embodiment, I_{SUM} is set to zero and is used to accumulate the output of the I channel A/D. Q_{SUM} is the equivalent in the Q channel. E is set to zero and is the accumulation counter. The next state is used to check whether the correct signal is present for proper accumulation via the QPSK_{ON} signal that comes from, for example, the Packet Tracking and Demodulation block, 710. The state machine remains in this state until QPSK_{ON}=true.

When QPSK_{ON}=true the state machine reads the outputs of the A/Ds, I_{D} and Q_{D}, 720. In the next state, 730, the state machine accumulates these values into values I_{SUM} and Q_{SUM}. In the next state, 740, the state machine increments the number of samples counter E_{SUM}. In the next state, 750, the state machine checks the value of N_{SUM} against a predefined accumulation period K. If the accumulation period has been reached the value of IQ_{diff} (the IQ gain offset in units of dBs of power) is computed. The calculation 20log10(I_{SUM}/Q_{SUM}) may be performed, for example, via a lookup table in an FPGA or arithmetically in a DSP.

If the accumulation period has not completed the state machines checks during the next state, 760, for EOP=true (End of Packet). If the packet has ended the state machine waits for the correct modulation to be present in the next available packet. If the packet has not ended the next set of A/D outputs is read and the process of accumulation is repeated.

In the embodiment described the accumulation occurs across many packets. This is intended to reduce the noise on the final output value IQ_{diff}. If a system has very long packets the integration may proceed across a single packet only before computing IQ_{diff}. State of the art system use packets of varying lengths depending on user data requirements and hence the number of packets used to compute a low noise version of IQ_{diff} is not known ahead of time.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
receiving a burst transmission signal having a first (I) component and a second (Q) component;
amplifying the signal with a variable gain amplifier;
sampling a magnitude of the amplified signal;
reducing the amplification provided by the variable gain amplifier by an amount greater than a predetermined headroom magnitude between a maximum signal level and a desired signal level if the magnitude of the amplified signal exceeds the maximum signal level;
sampling a magnitude of the signal amplified with the reduced amplification to determine whether the reduced amplification causes the signal to be within a predetermined range.

2. The method of claim 1 wherein the predetermined headroom magnitude comprises approximately one half of a range between a minimum signal level and the maximum signal level.

3. The method of claim 1 wherein reducing the amplification provided by the variable gain amplifier by an amount greater than a predetermined headroom magnitude between a maximum signal level and a desired signal level comprises reducing the power of the amplified signal by approximately 6 dB.

4. The method of claim 1 further comprising asserting a signal indicating automatic gain control lock when the magnitude of the signal is within a predetermined range of the desired signal level.

5. The method of claim 1 further comprising compensating for a difference in amplitude between the I component and the Q component.

6. The method of claim 1 further comprising increasing the amplification of the signal if the signal level is less than the desired signal level.

7. An apparatus comprising:
means for receiving a burst transmission signal having a first (I) component and a second (Q) component;
means for amplifying the signal with a variable gain amplifier;
means for sampling a magnitude of the amplified signal;
means for reducing the amplification provided by the variable gain amplifier by an amount greater than a predetermined headroom magnitude between a maximum signal level and a desired signal level if the magnitude of the amplified signal exceeds the maximum signal level;
means for sampling a magnitude of the signal amplified with the reduced amplification to determine whether the reduced amplification causes the signal to be within a predetermined range.

8. The apparatus of claim 7 wherein the predetermined headroom magnitude comprises approximately one half of a range between a minimum signal level and the maximum signal level.

9. The apparatus of claim 7 wherein reducing the amplification provided by the variable gain amplifier by an amount greater than a predetermined headroom magnitude between a maximum signal level and a desired signal level comprises reducing the power of the amplified signal by approximately 6 dB.

10. The apparatus of claim 7 further comprising means for asserting a signal indicating automatic gain control lock when the magnitude of the signal is within a predetermined range of the desired signal level.

11. The apparatus of claim 7 further comprising means for compensating for a difference in amplitude between the I component and the Q component.

12. The apparatus of claim 7 further comprising means for increasing the amplification of the signal if the signal level is less than the desired signal level.

13. An apparatus comprising:
a first variable gain amplifier to receive a first (I) component of a signal;
a second variable gain amplifier to receive a second (Q) component of the signal; and
a control circuit coupled with the first variable gain amplifier and the second variable gain amplifier, the control circuit to control the amplification provided by the first variable gain amplifier and the second variable gain amplifier, wherein the control circuit causes the gain provided by one or both of the variable gain amplifiers to be reduced by an amount greater than a predetermined headroom magnitude between a maximum signal level and a desired signal level if the magnitude of the amplified signal exceeds the maximum signal level.

14. The apparatus of claim 13 further comprising a first analog-to-digital converter coupled between the first variable gain amplifier and the control circuit and a second analog-to-digital converter coupled between the second variable gain amplifier and the control circuit.

15. The apparatus of claim 13 wherein the predetermined headroom magnitude comprises approximately one half of a range between a minimum signal level and the maximum signal level.

16. The apparatus of claim 13 wherein reducing the amplification provided by the variable gain amplifier by an amount greater than a predetermined headroom magnitude between a maximum signal level and a desired signal level comprises reducing the power of the amplified signal by approximately 6 dB.

17. The apparatus of claim 13 wherein the control circuit asserts a signal indicating automatic gain control lock when the magnitude of the signal is within a predetermined range of the desired signal level.

18. The apparatus of claim 13 wherein the control circuit compensates for a difference in amplitude between the I component and the Q component.

19. The apparatus of claim 13 wherein the control circuit causes the gain provided by one or both of the variable gain amplifiers to increase the amplification of the signal if the signal level is less than the desired signal level.
